(19) United States
(12) Patent Application Publication
(10) Pub. No.: US 2026/0365846 A1
(43) Pub. Date: Nov. 19, 2026

(54) ACRYLIC STYRENE COPOLYMERS FOR IMPROVING PROCESSING OF RECYCLED POLYESTERS

(71) Applicant: TECHMER PM, Clinton, TN (US)

(72) Inventors: Kaan SERPERSU, Clinton, TN (US); Steven Harold WILLIAMS, Clinton, TN (US); John Steven LONEY, Clinton, TN (US); Bhushan Janardan DESHPANDE, Clinton, TN (US)

(73) Assignee: TECHMER PM, Clinton, TN (US)

(21) Appl. No.: 19/126,142

(22) PCT Filed: Oct. 31, 2023
(86) PCT No.: PCT/US2023/036456

§ 371 Date: Apr. 30, 2025

Related U.S. Application Data
(60) Provisional application No. 63/421,026, filed on Oct. 31, 2022.

(51) Int. Cl. C08L 67/02

(52) U.S. Cl. CPC C08L 67/02; C08L 2207/20; C08L 2310/00

(57) ABSTRACT

Compositions and methods for additives that allow for the use of higher recycled content during processing are provided. The compositions and methods may produce resins having greater than 40 wt % recycled content with improved intrinsic viscosity and yellowness index measurements as compared with resins having a similar recycled content processed without the additives.

### CROSS-REFERENCE TO RELATED APPLICATIONS

This application claims the benefit of U.S. provisional application Ser. No. 63/421,026 filed Oct. 31, 2022, the disclosure of which is hereby incorporated in its entirety by reference herein.

### TECHNICAL FIELD

The present disclosure is related to the use of acrylic styrene copolymers in processing recycled polyester resins. The use of these copolymers improves and/or maintains the intrinsic viscosity (IV) within 15% of the original IV of the virgin resin, provides color stability of the recycled resin, and allows for the use of higher levels of recycled polyester resins while processing in film, blow molding, fiber, 3D printing, and injection molding applications.

### BACKGROUND

Plastics are an integral part of the manufacture, transport, purchase, and use of a vast number of industrial and consumer products. The negative environmental impact of plastics use, however, is well established. Although millions of pounds of polyester post-consumer resin (PCR) and post-industrial resin (PIR) are currently recycled, companies have aggressive targets for increasing the amount of recycling. The amount of recycled resins that can be used, however, is limited by the quality of the PCR or PIR used, processing issues, and color development.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 illustrates IV measurements for PET pellets that have been passed through an extruder at a standard PET temperature once (single pass) or twice (double pass) with or without the additive. An unrecycled PET is included as a control.

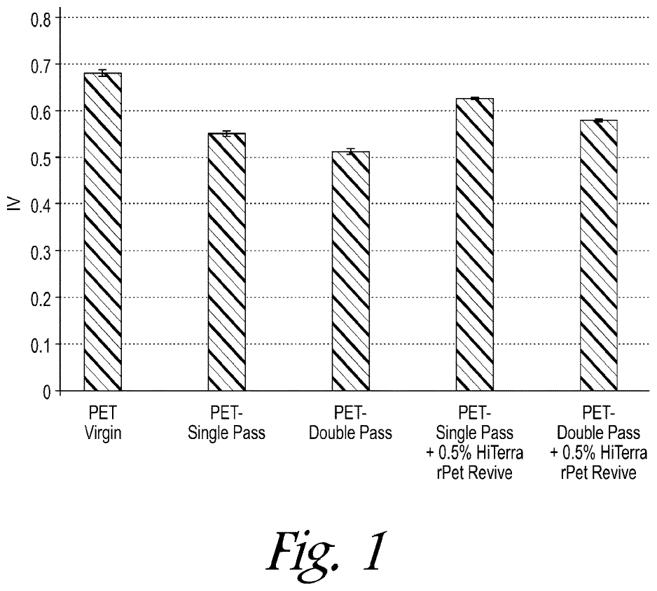

FIG. 2 illustrates PET pellets without the additive (control-left) and with the additive (right) that have been passed through an extruder at a standard PET temperature twice.

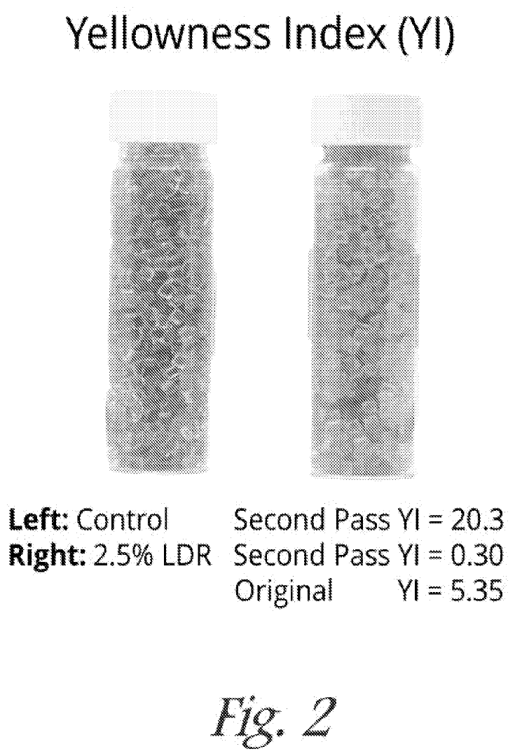

FIG. 3 illustrates 50% recycled PET without (left) and with (right) the additive.

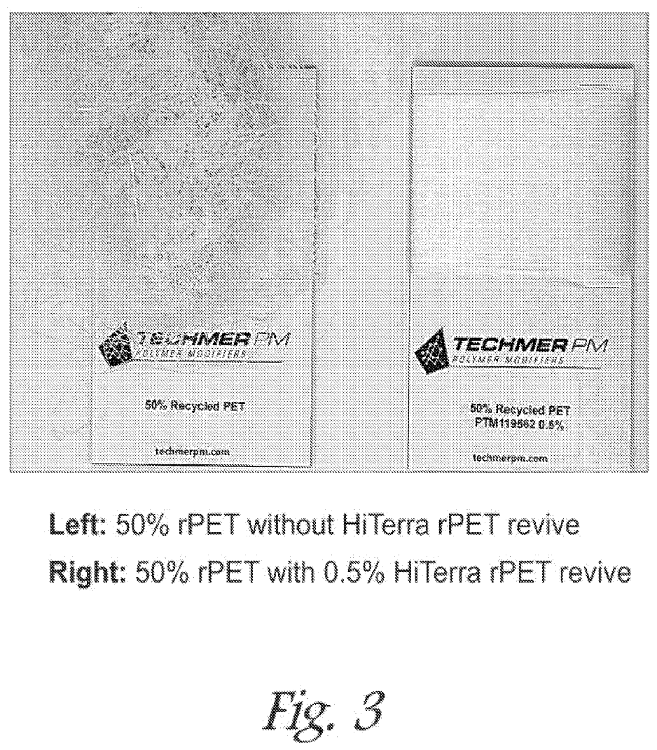

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, alylaryl (e.g., C₁₋₈ alkyl C₆₋₁₀ aryl), —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —OM*, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺is a metal ion, and L′ is a negatively charged counter ion; R groups on adjacent carbon atoms can be combined as —OCH₂O—; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups, M⁺ is a metal ion, and L′ is a negatively charged counter ion; hydrogen atoms on adjacent carbon atoms can be substituted as —OCH₂O—; when a given chemical structure includes a substituent on a chemical moiety (e.g., on an aryl, alkyl, etc.) that substituent is imputed to a more general chemical structure encompassing the given structure; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the invention can be obtained within a range of +/−5% of the indicated value.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The phrase “composed of” means “including” or “consisting of.” Typically, this phrase is used to denote that an object is formed from a material.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” and “multiple” as a subset. In a refinement, “one or more” includes “two or more.”

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numeral quantity, in a refinement, the term “less than” includes a lower non-included limit that is 5 percent of the number indicated after “less than.” For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, or 1 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)}O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

Throughout this application, where publications are referenced, the disclosures of these publications in their entireties are hereby incorporated by reference into this application to more fully describe the state of the art to which this invention pertains.

The following examples illustrate the various embodiments of the present invention. Those skilled in the art will recognize many variations that are within the spirit of the present invention and scope of the claims.

For nearly 60 years people have understood both the benefits and the negative implications of using plastics. The creation of the first plastic recycling mill in 1972 sparked a movement whereby environmental activists pushed for governmental programs educating manufacturers and consumers on the benefits and the necessity of recycling plastic. The use of plastic resins designed with the intent of recycling, such as HDPE and PETE rose in the 1980s. American cities began establishing their own recycling programs around this time, with curbside recycling programs increasing from around 1,000 in 1988 to almost 5,000 by 1992.

Polyesters are a family of polymers having ester groups in their main chain. Polyesters are widely used in consumer goods including clothing and other textiles, packaging, and single use plastics. Polyesters are also used during the manufacturing of a wide variety of goods including mouse pads, car tire reinforcements, liquid crystal displays (LCDs), and dielectric films. Synthetic polyesters are not biodegradable, and as such, account for a large volume of waste.

Fortunately, polyester products such as plastic water bottles and other packaging materials can be recycled. Polyester resins, such as polyethylene terephthalate (PET/PETE) or polybutylene terephthalate (PBT) which are thermoplastics, are used to make products such as plastic water bottles and packaging for other foods, beverages, toiletry items, cleaning solutions, and other goods. Plastic packaging materials composed of PET, for example, can be recycled by washing and remelting or by using chemicals to break the PET down into its individual chemical components to be used to generate new resin.

Post-consumer resin (PCR) can be generated from plastic waste from used water bottles and other such packaging. Post-industrial resin (PIR) is formed from waste generated by the manufacturing process. PCR is prone to impurities that can affect the quality of products, due to the fact that consumer waste has to be properly cleaned and sorted before being processed into resin. Despite these drawbacks, PCR is highly coveted material because it removes waste that would otherwise overwhelm landfills. As such, products and processes that allow for increased use of PCR and also lower quality PIR without sacrificing quality are needed.

The ability of a polymer to increase the viscosity of a solvent is described as the intrinsic viscosity of the polymer. This measurement can be used to determine certain characteristics of the polymer such as the molecular weight, shape, polymerization, degradation, and others.

When post-consumer materials are collected at recycling centers, they are separated by general material category. For example, all of the PET containers such as water, soft drink, and orange juice bottles may all be mixed together along with salad dressing, peanut butter, and cooking oil containers. Due to the differing nature of the materials for which the packaging is made, the PET may be of different grades. These differences can lead to variable intrinsic viscosity within the mixture, which can affect the physical characteristics of the polymers, thereby affecting the processability.

Polymeric resin derived directly from petrochemicals is called prime resin. Companies using recycled resin such as PCR or PIR, often mix the PCR and PIR in with prime resin. The intrinsic viscosity of PCR and PIR, however, is often different from that of the prime resin. The size of the difference in intrinsic viscosity between the recycled and the prime resins determines how much recycled resin can be mixed in. Having recycled resin with an improved intrinsic viscosity allows for the addition of more recycled resin in applications.

In at least one aspect, the present disclosure relates to a masterbatch composition for use as an additive that functions to improve the intrinsic viscosity of a recycled resin, and that allows for the use of higher recycled content during processing. The terms “masterbatch” and “additive” may be used interchangeably to refer to the masterbatch composition. The amount of recycled polyester resin that can be processed without the additive may vary by recycle source, quality, and process sensitivity. Parameters including the purity, starting intrinsic viscosity, and starting yellowness of recycled PET may affect the amount of recycled PET that may be used when producing a product. An intrinsic viscosity between about 0.6 and 0.9 is optimal for processing of PET. Recycled PET resin can drop as low as about 0.4 during processing without additives. Inclusion of the additive with recycled PET according to at least some embodiments may improve the intrinsic viscosity of the resin to a level of about 0.6-0.9. Inclusion of the additive with recycled PET according to at least some embodiments may also stabilize the intrinsic viscosity at a level of about 0.6 to 0.9 through multiple passes. For example, a recycled PET resin including 0.15 to 5 weight % of the masterbatch that has been processed at least once may have an intrinsic viscosity of 0.5 to 1.1, or from 0.55 to 0.95, or from 0.6 to 0.85, as measured in accordance with ASTM D4603.

Additionally, recycled PET becomes more yellow in color as it is processed. This yellow color is undesirable in final products. The yellowness of a resin is measured by the yellowness index (YI), in accordance with ASTM E313. Most processes using recycled PET may include 10 to 20 wt % recycled PET without significantly compromising color quality. Above 40 wt % recycled PET with no additive, however, will produce a product with YI>0. When using the additive according to at least some embodiments, greater than 40 wt % recycled PET may produce a product with a yellowness index of less than 0. For example, resins including the additive and from 10 to 99.75, or from 25 to 99, or from 40 to 97.5 wt % recycled PET may produce a product with a yellowness index of less than 0. For example, resins including the additive and from 10 to 99.75, or from 25 to 99, or from 40 to 97.5 wt % recycled PET may produce a product with a yellowness index of 0 to −10, or −2 to −8, or −4 to −6, as measured in accordance with ASTM E313.

The additive may comprise acrylic styrene copolymers, and a carrier resin. The additive may optionally contain synergistic components or other functional components based on the specific usage and application, including but not limited to, flame retardants, UV protective additives, slips, antiblocks, scents, antioxidants, pigments, antifogs, antistatics, dispersing agents, waxes, clarifying agents, reinforcements such as glass fiber or carbon fiber, fillers, clarifying agents, process aids, and wetting agents. These may potentially be used with the acrylic styrene copolymer in various combinations.

Acrylic styrene copolymers, include acrylic acid and its esters. Acrylic-based monomers may combine with styrene through emulsion polymerization to form acrylic-styrene polymers. Examples of acrylic-based monomers that may be used to form the acrylic-styrene polymers comprising the additive may include but are not limited to, methyl acrylate, butyl acrylate, ethyl acrylate, methacrylate, methyl methacrylate, and 2-ethylhexyl acrylate. In at least one embodiment, the acrylic styrene copolymers may comprise a mixture of two components. The first component may comprise between 30 and 60, or 35 and 55, or 40 and 50 wt % of an acrylic copolymer. The second component may comprise between 30 and 60, or 35 and 55, or 40 and 50 wt % of a styrene copolymer. In at least one embodiment, suitable acrylic styrene copolymers may have a bulk/packing density above 0.44 g/cm³ as measured by ASTMD6683. The acrylic styrene polymers may have a bulk/packing density of about 0.4 to about 1.0, or 0.5 to 0.95, or 0.44 to 0.7 g/cm³. The acrylic styrene copolymers may have a specific gravity from 0.9 to 1.4, or from 1 to 1.3, or from 1.1 to 1.2 as measured by ASTM D792. Examples of suitable acrylic styrene copolymers are commercially available from Kaneka and other chemical manufactures.

The carrier resin may be a polymer. The polymer may be a member of the polyester family, including but not limited to polyethylene terephthalate (PET), polyethylene terephthalate glycol (PETG), recycled PETG, polylactic acid (PLA), polybutlene succinate (PBS), polybutylene adipate-co-terephthalate (PBAT), polyhydroxyalkanoates (PHA), polyhydroxybutyrate (PHB), or polybutylene terephthalate (PBT). The carrier resin may have a lower viscosity than the resin with which it will be mixed to allow for good dispersion. The carrier resin may be compatible with a base resin, which is a user resin that needs stabilization and/or improvement The carrier resin may be prime resin. In the alternative, the carrier resin may be recycled resin. Whether the carrier resin is prime resin or recycled resin may depend on the use. For instance, the carrier resin may be recycled resin for 3D printing uses.

The amount of acrylic styrene copolymers present in the additive may be from at least about 0.5 to about 30, or from about 2 to 25, or about 10 to 20 wt %. For example, the amount of acrylic styrene copolymers present in the additive may be at least about 0.5, or at least about 1, or at least about 2, or at least about 3, or at least about 4, or at least about 5, or at least about 10, or at least about 15, or at least about 20, or at least about 25, or about 30 wt %. The amount of acrylic styrene copolymers present in the additive may vary depending on the particular equipment possessed by the user of the additive. For example, the amount of acrylic styrene copolymers present in the additive may vary based on the letdown ratio at which a masterbatch can be fed on a particular equipment setup.

The amount of carrier resin present in the additive may be from at least about 40 to 99.75, or about 50 to 85, or about 55 to 70 wt %. For example, the amount of carrier resin present in the additive may be at least about 40, or 45, or 50, or 55, or 60, or 65, or 70, or 75, or 80, or 85, or 90, or 95, or at least about 99.5 wt %.

In other aspects, methods for forming a masterbatch form of the additive or a compound of the additive for use is improving recycled resins are provided. To generate the useable form of the additive, the acrylic styrene copolymers and the carrier resin may be mixed together. For example, the acrylic styrene copolymers and the carrier resin may be heated and mixed together. The mixture may be heated to a temperature of 350 to 550, or 400 to 525, or 450 to 500 °F. The mixture may then be extruded using a single screw or a twin screw extruder, for example. The extruded mixture may then be cooled and formed into flakes, granules, powders, pellets, or other suitable masterbatch forms for use in film extrusion, blow molding, fiber, sheet, non-wovens, 3D printing, injection molding, blown film, cast film, profile extrusion, and/or other suitable applications. Processing parameters for the masterbatch such as screw design, temperature profile, and pellet design may prevent the premature reaction of the additive with the carrier resin. For instance, the screws may be specifically designed for low shear and low temperature to prevent premature activation of the chemical during processing. Additionally, the pellet size of the masterbatch measured by pellets per gram (PPG) may be 70-100, or 75-90, or 72-85 rather than the standard PPG of 40-60. The smaller pellet size may promote melting and mixing during processing. Processing parameters including screw rotation speed, screw element design, feed rate, production rate and barrel temperature may also affect the mechanical energy that is transferred to a material during an extrusion process. This energy, referred to as specific mechanical energy, represents the energy per mass unit transferred to the material by mechanical input during extrusion. Specific mechanical energy is affected by parameters such as shear intensity, residence time and melt temperature. The specific mechanical energy during extrusion of the masterbatch may be from 0.10 to 0.30, or from 0.12 to 0.27, or from 0.15 to 0.25 kW/(kg/hr).

The additive may be used as a masterbatch, in which it is mixed with a base resin during processing in a chosen ratio of additive to resin, as well as optional components including but not limited to, flame retardants, UV protective additives, slips, antiblocks, scents, antioxidants, pigments, antifogs, antistatics, dispersing agents, waxes, clarifying agents, reinforcements such as glass fiber or carbon fiber, fillers, clarifying agents, process aids, and wetting agents.

The additive may be used as a masterbatch to produce a final product including but not limited to films, bottles, food containers, 3D printed materials, or fibers. The additive may alternatively be used to produce a composition containing recycled resin. For instance, the additive in masterbatch form may be added to a base resin at a letdown rate from about 0.15-5 wt %, preferably from about 0.2-4.0 wt %, more preferably from about 0.25-3.25 wt %. Most preferably, the additive may be added in masterbatch form at a letdown rate from about 0.5-2.5 wt %. The base resin may comprise up to 100 wt % recycled resin. For example, the base resin may comprise 10 to 100, or 20 to 90, or 40 to 80 wt % recycled resin. A letdown rate of 2.5 wt % for example, means that the final mixture will contain 2.5 wt % additive and 97.5 wt % base resin. After mixing the additive with the base resin and optional components, the mixture may be extruded, cooled and formed into flakes, granules, powders, pellets, or other suitable masterbatch forms for use in film extrusion, blow molding, fiber, sheet, non-wovens, 3D printing, injection molding, blown film, cast film, profile extrusion, and/or other suitable applications. The flake or pellet produced by the process may comprise up to about 97.5 wt % recycled resin.

The additive may also be used as a fully formulated compound. The term “compound” refers to a composition containing the masterbatch composition including the acrylic styrene copolymer and carrier resin plus the base resin along with optional components including but not limited to, flame retardants, UV protective additives, slips, antiblocks, scents, antioxidants, pigments, antifogs, antistatics, dispersing agents, waxes, clarifying agents, reinforcements such as glass fiber or carbon fiber, fillers, clarifying agents, process aids, and wetting agents. After mixing the additive with the base resin and optional components, the mixture may be extruded, cooled and formed into flakes, granules, powders, pellets, or other suitable masterbatch forms for use in film extrusion, blow molding, fiber, sheet, non-wovens, 3D printing, injection molding, blown film, cast film, profile extrusion, and/or other suitable applications. The compound may be used directly to form final products including but not limited to films, bottles, food containers, 3D printed materials, or fibers.

In other embodiments, a method for processing recycled resin is provided. The method may comprise providing the masterbatch comprising an acrylic styrene copolymer with a carrier resin. In one embodiment, this component can be provided by mixing an acrylic styrene copolymer with a carrier resin under heat and shear stress to form a masterbatch. Then a resin component comprising recycled resin and optionally prime resin is/are provided and mixed under heat and shear stress to form a base resin. The resin component may also be provided as an already blended resin. The resin component may comprise about 10 to 100, or 20 to 90, or 40 to 80 wt % recycled resin, with the remainder comprising at least prime resin and optionally other processing aids. The masterbatch may then be added to the resin component and blended under heat and shear stress to form a recycled resin compound. The masterbatch may be added to the resin component in an amount from 0.15 to 5, or 0.5 to 3.5, or 1 to 2.5 wt %. The recycled resin compound may then be cooled and formed into flakes, granules, powders, pellets, or other suitable masterbatch forms for use in film extrusion, blow molding, fiber, sheet, non-wovens, 3D printing, injection molding, blown film, cast film, profile extrusion, and/or other suitable applications. The recycled resin compound may be used directly to form final products including but not limited to films, bottles, food containers, 3D printed materials, or fibers.

The additive may be used to address the following non-limiting useage conditions: color, nucleation, UV, contents protection, scratch and mar (bottles), improved wear properties, antimicrobial, thermal enhancement (AO), and reinforcement (GF/CF compounds).

Environmental effects including moisture occurring or introduced during the processing of resins may lower the intrinsic viscosity of the resin, affecting processing conditions and thereby the quality of the final product. The additive increases the intrinsic viscosity of the resin mixture during processing. Increased intrinsic viscosity leads to improved processing conditions, and consequently enhanced product quality. In this way, higher amounts of recycled resin or lower quality recycled resin may be used without affecting product quality. Additionally, grey or yellow coloring can occur upon repeated heating of PET, affecting the applications of recycled resins. Use of the additive during processing reduces color development, which in turn allows for increased use of recycled resin without negative affects on product quality. Overall, the additive will allow a user to include or increase the amount of recycled material included in final parts or will allow for the use of recycled resins in compounds for applications such as 3D printing.

### EXAMPLES

### Example 1: Measuring Intrinsic Viscosity and Yellow Index

The intrinsic viscosity (IV) and yellow index (YI) for PET alone (Control PET); PET plus either 2.5 or 5 wt % of the additive; or PET plus one of four alternative additives having different chemistry (listed as active ingredient) from the additive disclosed herein. IV was measured per ASTM D4603, Yellowness Index was measured per ASTM E313.

### Results:

| Material (wt %) | Active Ingredient | IV (dL/g) | YI |
|---|---|---|---|
| 100% Control PET - | N/A | 0.84 | 5.4 |
| Original | | | |
| 100% Control PET - | N/A | 0.78 | 14.8 |
| Repass 1 | | | |
| 100% Control PET - | N/A | 0.75 | 20.3 |
| Repass 2 | | | |
| 2.5% Additive - Repass 1 | acrylic styrene | 0.94 | −4.2 |
| | copolymer | | |
| 2.5% Additive - Repass 2 | acrylic styrene | 0.91 | 0.3 |
| | copolymer | | |
| 5% Additive - Repass 1 | acrylic styrene | 1.19 | −4.2 |
| | copolymer | | |
| 5% Additive - Repass 2 | acrylic styrene | 1.05 | −0.2 |
| | copolymer | | |
| 0.5% PTM110239 | Joncryl ADR 4468 | 0.81 | −6.1 |
| 1.5% PTM110239 | Joncryl ADR 4468 | 0.77 | −6.7 |
| 1% PTM110481 | Pyromellitic dianhydride | 0.71 | 7.4 |
| 3% PTM110481 | Pyromellitic dianhydride | 0.65 | −3.7 |
| 1% PTM116253 | Zemac E60 | 0.61 | 7.3 |
| 3% PTM116253 | Zemac E60 | 0.7 | 7.1 |
| 1% PTM116254 | Xibond 280 | 0.68 | −3.3 |
| 3% PTM116254 | Xibond 280 | 0.67 | −0.5 |

### Example 2: Testing Tensile Stress and Elongation, and Notched Izod Impact

The average tensile strength at yield and at break, and the average tensile elongation at break were measured using ASTM D638. The materials measured were 100 wt % R-PET resin, and either 1, 2.5 or 5 wt % of an embodiment of the additive mixed with either 99, 97.5, or 95 wt % R-PET resin. Additionally, notched Izod impact was measured for the same materials using Method A of ASTM D256.

### Results:

| | | 100 wt % | | | |
|---|---|---|---|---|---|
| | | R-PET | 1 wt % | 2.5 wt % | 5 wt % |
| | | Resin | Additive | Additive | Additive |
| | | (Customer | in R-PET | in R-PET | in R-PET |
| Test | Parameter | Resin) | Resin | Resin | Resin |
| ASTM | Average Tensile Stress at | 60 ± 1.2 | 60 ± 1.3 | 60 ± 0.5 | 60 ± 0.3 |
| D638 | Yield (MPa) | | | | |
| (Strain | Average Tensile Stress at | 27 ± 1.0 | 27 ± 2.4 | 30 ± 4 | 34 ± 3 |
| rate of | Break (MPa) | | | | |
| 2.0 | Average Tensile | 50 ± 20 | 65 ± 20 | 160 ± 50 | 150 ± 100 |
| in/min) | Elongation at break (%) | | | | |
| ASTM | Average Notched Izod | 0.56 | 0.58 | 0.55 | 0.56 |
| D256 | impact (ft-lbs/in) | | | | |
| (Method | Break Type (C- | 5/5 | 5/5 | 5/5 | 5/5 |
| A) | Complete, H - Hinge, P - | Complete | Complete | Complete | Complete |
| | Partial, NB - No Break) | | | | |

### Example 3: Measuring Intrinsic Viscosity and Yellow Index at Lower Let Down Rates

### PET

The intrinsic viscosity (IV) and yellow index (YI) for virgin PET and recycled PET processed by a single or double pass with or without 0.5 wt % of the acrylic styrene copolymer additive were measured. IV was measured per ASTM D4603, Yellowness Index was measured per ASTM E313.

### Results:

| Sample | AVG IV | YI |
|---|---|---|
| PET - Virgin | 0.68 ± 0.007 | −7.0 |
| PET - single pass | 0.55 ± 0.006 | 0.4 |
| PET - double pass | 0.51 ± 0.006 | 3.2 |
| PET - single pass + 0.5 wt % masterbatch | 0.63 ± 0.002 | 0.1 |
| PET - repassed + 0.5 wt % masterbatch | 0.58 ± 0.003 | 2.3 |

### PBT

The intrinsic viscosity (IV) and yellow index (YI) for virgin PBT and recycled PBT processed by a single or double pass with or without 0.5 wt % of the additive were measured. IV was measured per ASTM D4603, Yellowness Index was measured per ASTM E313.

### Results:

| Sample | AVG IV | YI |
|---|---|---|
| PBT - Virgin | 0.74 ± 0.002 | −1 |
| PBT - single pass | 0.73 ± 0.007 | 3.6 |
| PBT - double pass | 0.75 ± 0.026 | 5.0 |
| PBT - single pass + 0.5 wt % masterbatch | 0.79 ± 0.010 | 0.1 |
| PBT - repassed + 0.5 wt % masterbatch | 0.78 ± 0.006 | 2.7 |

### Example 4: Measuring Intrinsic Viscosity and Yellow Index of Recycled Resin

Recycled resin alone as a control or with 0.25, 0.50 or 1.00 wt % of the additive was processed as a single or double pass (“repass”). Intrinsic viscosity and yellow index were measured. IV was measured per ASTM D4603, Yellowness Index was measured per ASTM E313.

### Results:

| | IV Result | Yellowness |
|---|---|---|
| Sample ID | (dL/g) | Index |
| Control - 100 wt % Recycled Resin before | 0.64 | −1.3 |
| pelletizing | | |
| 1 - Recycled Resin at 100 wt % | 0.65 | 9.3 |
| 2 - Repass of 1 | 0.62 | 10.6 |
| 3 - Recycled Resin at 99.75 wt % with 0.25 | 0.65 | 8.3 |
| wt % Additive | | |
| 4 - Repass of 3 | 0.64 | 9.6 |
| 5 - Recycled Resin at 99.50 wt % with 0.50 | 0.64 | 7.3 |
| wt % Additive | | |
| 6 - Repass of 5 | 0.63 | 9.5 |
| 7 - Recycled Resin at 99.00 wt % with 1.00 | 0.66 | 6.7 |
| wt % Additive | | |
| 8 - Repass of 7 | 0.62 | 8.9 |

As described above, optional components may be added to the masterbatch form of the additive, or added separately during processing. Notched Izod impact properties of recycled PETG resin processed with a masterbatch comprising the acrylic styrene copolymers, carrier resin and 30 wt % glass fiber were measured. The table below shows the results from samples containing 30 wt % glass fiber filled recycled PETG resin alone as a control or 30 wt % glass fiber filled recycled PETG along with 0.2, 0.4, or 0.6 wt % of the additive according to an embodiment. The samples were processed as a single pass and compared for notched Izod impact properties per Method A ASTM D256.

### Results:

| | 0 wt % | 0.2 wt % | 0.4 wt % | 0.6 wt % |
|---|---|---|---|---|
| | additive | additive | additive | additive |
| NI Cond ftlb/in | 1.4000 | 1.42 | 1.4600 | 1.5900 |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A masterbatch composition comprising:
an acrylic styrene copolymer having a specific gravity of 0.9 to 1.4; and
a carrier resin.

2. The masterbatch composition of claim 1, wherein the acrylic styrene copolymer has a bulk density of 0.44 to 0.70 g/cm³.

3. The masterbatch composition of claim 1, wherein the acrylic styrene copolymer comprises 30 to 60 weight % of an acrylic polymer and 30 to 60 weight % of a styrene polymer based on the total weight of the acrylic styrene copolymer.

4. The masterbatch composition of claim 1, wherein the acrylic styrene copolymer comprises 10 to 20 weight % based on the total weight of the composition.

5. The masterbatch composition of claim 1, wherein the carrier resin is a polyester resin.

6. The masterbatch composition of claim 1, wherein the carrier resin is recycled resin.

7. A recycled resin blend comprising:
0.15 to 5 weight % of the masterbatch of claim 1 based on the total weight of the compound; and
base resin comprising 41 to 99.85 weight % recycled resin,
wherein the compound has an intrinsic viscosity of 0.6 to 0.9 dl/g.

8. The recycled resin blend of claim 7, wherein the recycled resin blend has an intrinsic viscosity 40 to 75% higher than the intrinsic viscosity of a recycled resin blend without the masterbatch.

9. A method for forming a masterbatch composition comprising:
mixing an acrylic styrene copolymer comprising 30 to 60 weight % of an acrylic polymer and 30 to 60 weight % of a styrene polymer based on the total weight of the acrylic styrene copolymer with a carrier resin to form a mixture;
heating the mixture;
applying a production energy to the mixture to promote uniform blending, wherein the mixture is subjected to a specific mechanical energy from 0.15 to 0.25;
cooling the mixture; and
forming the mixture into pellets.

10. The method of claim 9, further comprising mixing 0.5 to 30 weight % of the acrylic styrene copolymer based on the total weight of the masterbatch with the carrier resin.

11. The method of claim 9, further comprising heating the mixture to a temperature of 450 to 500 °F.

12. The method of claim 9, further comprising forming the mixture into pellets of a size of 70 to 100 pellets per gram.

13. A method for processing recycled resin comprising:
providing a masterbatch comprising an acrylic styrene copolymer with a carrier resin;
providing a resin component comprising recycled resin and optionally prime resin;
mixing 40 to 99.85 weight % of the resin component with 0.15 to 5 weight % of the masterbatch under heat and shear stress to form a recycled resin compound;
cooling the recycled resin compound; and
forming the recycled resin compound into pellets.

14. The method of claim 13, wherein the recycled resin compound has an intrinsic viscosity of 0.6 to 0.9 dl/g.

15. The method of claim 13, wherein the intrinsic viscosity of the recycled resin compound is 40 to 75% higher than the intrinsic viscosity of a similar compound without the masterbatch.

16. The method of claim 13, wherein the recycled resin compound has a yellowness index of less than 0.

17. The method of claim 13, wherein the prime resin is present and the prime resin and the recycled resin are polyethylene terephthalate.

18. The method of claim 13, wherein the prime resin is present and the prime resin and the recycled resin are polybutylene terephthalate.

19. The method of claim 13, further comprising subjecting the pellets to a repass.

20. The method of claim 19, wherein the intrinsic viscosity of the repassed pellets is 0.6 to 0.9.
